(19) United States
(12) Patent Application Publication
(10) Pub. No.: US 2019/0079315 A1
(43) Pub. Date: Mar. 14, 2019

(54) NEW PROCESS FOR PARTIAL MIRRORING OF GLASSES, AND GLASSES OBTAINED THROUGH THE PROCESS

(71) Applicant: DALLOZ CREATIONS, Saint-Claude (FR)

(72) Inventor: Bruno CORNET, Oyonnax (FR)

(73) Assignee: DALLOZ CREATIONS, Saint-Claude (FR)

(21) Appl. No.: 16/122,515

(22) Filed: Sep. 5, 2018

(30) Foreign Application Priority Data
Sep. 14, 2017 (FR) 1700922

(51) Int. Cl. G02C 7/02; B23K 26/362; B23K 26/40

(52) U.S. Cl. CPC G02C 7/02; B23K 2103/50; B23K 26/40; B23K 26/362

(57) ABSTRACT

A new method for partial silvering of spectacle lenses, and lenses obtained using said method. Applied to spectacle lenses comprising a varnished substrate on which one or several thin layers are arranged, uses a digitally controlled laser, said laser emitting through a solid fiber, the wavelength used being in the near infrared. When these lenses comprise three thin layers it is possible, by using the method according to the invention, to achieve partial silvering in which the laser has eliminated: the thin layers on a first part thereof, until reaching the varnished substrate, then the thin layers on a part thereof, revealing a part of the thin layer, and lastly the thin layer, on a part thereof, revealing a part of the thin layer.

The present invention relates to a new method for partial silvering of spectacle lenses, as well as the lenses obtained using said method.

Spectacle lenses are commercially available, in particular solar lenses, having a reflective surface, this feature giving said lenses a mirror effect. This effect, in this description subsequently called “silvering”, is obtained in particular by depositing thin layers on said lenses made by stacking one or several different materials.

The silvering is obtained on solar lenses using several methods, including:
simple silvering, obtained by evaporating a reflective material,
complex silvering, obtained by stacking materials, which, in their assembly, will yield a reflective effect.

It appeared interesting to try to obtain a partial silvering, i.e., showing zones or designs where the reflective surface does not exist, thus constituting etching of said lenses.

Several methods have been designed making it possible to arrive at such partial silvering.

One method, called “pad printing” and consisting of a printing system making it possible to mark any type of medium, has a number of drawbacks, and in particular a lack of precision, difficulty in the fineness of the lines, a lack of flexibility in the implementation, a limited printing size in that the buffer may leave the marking zone, a limited rhythm and a lack of repeatability.

Another method consists of using covers or masks when depositing the thin layer(s) on the lenses; such a method, aside from the drawbacks noted in the case of pad printing, has the drawback of a restriction in the marking models, since the covers or masks correspond to a single type of design.

Another method uses a CO2 laser that will destroy certain zones of the reflective layer so as to reveal a design through the absence of reflective effect in said zones. Such a method will etch the lens in the form of fragments: this etching lacks control and may also result in microcracks.

The method according to the invention avoids the aforementioned drawbacks, while having specific advantages that will be cited in more detail in the present description.

More specifically, the method according to the invention allowing the partial silvering, or etching, of spectacle lenses, in particular solar lenses, comprising a varnished substrate on which one or several thin layers are deposited, where each thin layer is made up of evaporable materials, generally having a reflective effect, and commonly used in vacuum sunglass treatments, consists of using a digitally controlled laser, said laser emitting through a solid fiber, the wavelength used being in the near infrared.

According to one preferred embodiment, the laser beam is emitted through a solid fiber made from a metal belonging to the rare earths according to the periodic table of the elements.

According to one alternative embodiment, the wavelength used is between 1,000 and 1,100 nm.

Other advantages and features will emerge upon reading the following description, done in light of the figures, provided for information and non-limitingly, in which:

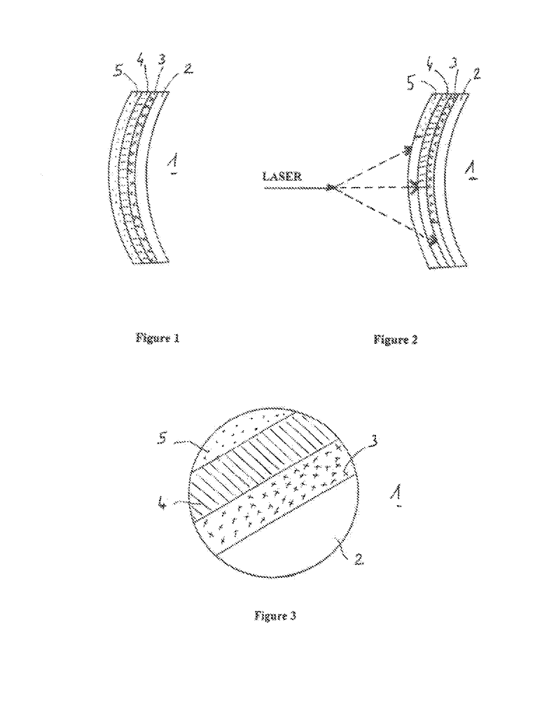

FIG. 1 is a cross-sectional view of a lens provided with several thin layers of materials,

FIG. 2 corresponds to a front view of the lens of FIG. 1, after laser treatment, and

FIG. 3 shows a front view of the lens of FIG. 2.

According to FIG. 1, the spectacle lens generally referenced (1) is schematically made up of a varnished substrate (2) on which three thin layers (3), (4), (5) are deposited; each thin layer is made up of evaporable materials commonly used in vacuum treatments for sunglasses, the assembly generally having a reflective effect. As a non-limiting example, the reflective effect is obtained owing to a thin layer made from a reflective material, for example a reflective metal, the latter being able to be chromium or a precious metal, such as gold or platinum.

Before the laser treatment, the thin layers (3), (4), (5) cover the entire varnished substrate (2).

The laser used in the present invention is controlled digitally and no longer manually, which causes fewer defects on the finished piece; furthermore, this control being digital, the programming of the designs, or patterns, to be etched on the spectacle lens is quick and flexible.

FIG. 2 shows that, in the selected partial silvering, the laser has eliminated:
the thin layers (3), (4), (5) on a first part thereof, until reaching the varnished substrate (2),
then the thin layers (4) and (5), on a part thereof, revealing a part of the thin layer (3),
and lastly the thin layer (5), on a part thereof, revealing a part of the thin layer (4).

FIG. 3 shows the appearance of the lens (1) after the laser treatment as previously described: one can thus see that the varnished substrate (2) and the thin layers (3), (4) and (5) are visible from the side of a viewer looking at the spectacles worn by the user, whose vision is in no way impaired by this laser treatment.

In FIGS. 1 to 3, the lens is shown with three thin layers of materials; it is understood that the method according to the invention also applies irrespective of the number of thin layers.

As previously mentioned, the CO₂ laser comprises various drawbacks; in order to overcome them, it appears that the best results in terms of partial silvering were obtained by using a filtered laser using a source diode and emitting through a solid filter, for example ytterbium or any other metal made up of a rare earth within the meaning of the periodic table of elements, capable of serving as a fiber transmitting the laser beam.

Preferably, the central wavelength will be in the near infrared; more preferably, the selected wavelength will be around 1,000 to 1,100 nm, and more particularly between 1,050 and 1,070 nm. As a comparison, the CO₂ laser works with a wavelength of about 10,000 nm.

According to one advantageous alternative embodiment of the method according to the invention, good results are obtained with a laser beam whose diameter is between 18 and 30 microns and is preferably about 25 microns, thus allowing good precision. Furthermore, an etching will be made up of a series of points, not individually perceptible to the naked eye, but which, combined, yield a result called effect, pattern or design.

The best results in terms of fineness and precision in the etching of lenses, in particular solar, were obtained by using these elements as previously described—type of laser control, rare earth fiber, near infrared wavelength, diameter of the beam—in combination.

The contributed precision and fineness are appropriate for the thin layers that the Applicant uses on its varnished substrate; indeed, this type of laser makes it possible to be selective in the etched thickness or thicknesses, and offers a broad panel of possibilities with respect to partial silvering needs, in particular for solar lenses.

It should be noted that the implementation of the method according to the invention substantially limits, or even avoids environmental bothers; indeed, no chemical products are deposited on the lens to be etched, and as a result, there is no chemical discharge when the etching operation is carried out.

1. A method allowing the partial silvering, or etching, of spectacle lenses, in particular solar lenses, comprising a varnished substrate on which one or several thin layers are deposited, where each thin layer is made up of evaporable materials, generally having a reflective effect, and commonly used in vacuum sunglass treatments, characterized in that it consists of using a digitally controlled laser, said laser emitting through a solid fiber, made from a metal belonging to the rare earths according to the periodic table of elements, the wavelength used being in the near infrared.

2. The method according to claim 1, wherein the metal belonging to the rare earths is ytterbium.

3. The method according to claim 1, wherein said wavelength is between 1,000 and 1,100 nm.

4. The method according to claim 3, wherein said wavelength is between 1,050 and 1,070 nm.

5. The method according to claim 1, wherein the beam of said laser has a diameter between 18 and 30 microns.

6. The method according to claim 5, wherein said diameter is about 25 microns.

7. The method according to claim 1, wherein said reflective effect is obtained owing to a thin layer made from a reflective metal.

8. The method according to claim 7, wherein said reflective metal is chromium or a precious metal such as gold or platinum.

9. Spectacle lenses, in particular solar, for which partial silvering is obtained using a method according to claim 1.
